(19) United States
(12) Patent Application Publication
(10) Pub. No.: US 2011/0082729 A1
(43) Pub. Date: Apr. 7, 2011

(54) SYSTEM FOR IN-STORE COUPON DISTRIBUTION AND REDEMPTION

(76) Inventors: Jesus Carvallo, Weston, FL (US); Raul A. Salazar, Weston, FL (US)

(21) Appl. No.: 12/575,012

(22) Filed: Oct. 7, 2009

(51) Int. Cl. G06Q 30/00; G06Q 10/00; H04B 7/00; G06F 3/041; G08B 21/18; H04L 9/00

(52) U.S. Cl. 705/14.13; 705/14.26; 705/14.36; 705/14.38; 455/41.2; 345/173; 340/686.6; 235/380; 713/150

(57) ABSTRACT

Systems and methods for processing of electronic coupons are disclosed. A plurality of touch screen devices are deployed in aisles of a store. The touch screen devices display coupons for products located in the corresponding aisles after administration devices detect the presence of a registered user in an aisle. The touch screen device accepts selection of coupons and the selections are uploaded to a main server. A point-of-sale administration device detects the presence of a registered user and downloads the pre-selected coupons from main servicer for redemption.

### FIELD OF THE INVENTION

The present invention relates to data processing systems and methods for the generation, distribution and redemption of coupons over a network. More particularly, the present invention relates to integrated systems and methods which provide secure electronic coupon redemption by using wireless technology to connect mobile devices to an in-store network and using the mobile devices as communication and identification tools interfacing with hardware components in the business locations or stores.

### BACKGROUND OF THE INVENTION

Discount coupons and similar purchase incentives have long been distributed to consumers to promote the sale of goods or services. Typically, advertisers issue printed coupons which can be redeemed at a local retail outlet (or by mail) for a discount or refund upon making a purchase of goods identified by the coupon. While this method of promotion is somewhat effective, it has caused problems for manufacturers, consumers and merchants due to its massive inefficiency.

Around 300 billion printed coupons are distributed annually throughout the United States. Only between 2% and 5% of such coupons are redeemed by consumers. The small percentage of discount coupons that are actually redeemed reveals that most consumers use discount coupons infrequently. This may be due to the inconvenience associated with selecting and redeeming printed coupons.

For instance, in order to obtain a small number of relevant discount coupons, a consumer is normally required to search for and clip such coupons from a plurality of publications containing many other irrelevant and unwanted coupons. The consumer must therefore clip, categorize, sort and store in an organized manner the relevant coupons for use upon his or her next visit to a retail outlet, such as a grocery store. This conventional method of coupon distribution has a disadvantage in that many consumers simply lack the time or initiative to search for and clip coupons. Thus, printed coupons issued by manufacturers and retailers generally reach only a small segment of the consuming public, i.e., those who clip coupons based upon personal interest or financial necessity. Although manufacturers may wish to reach a larger percentage of consumers having the greatest spending power, many such consumers do not clip coupons due to the inordinate amount of time required to do so.

Attempts to overcome this drawback include the coupon book and the discount card. Local merchants often participate in promotional campaigns including the use of coupon books which eliminate the need for consumers to search through local newspapers for such coupons. However, coupon books are generally subject-oriented and are impracticable for use in connection with a large variety of goods, such as groceries. A form of purchase incentive applicable to grocery stores and the like utilizes a discount card, which is similar in appearance to a credit card, and is distributed to all interested consumers. The card is imprinted with coded magnetic indicia to identify the cardholder. During checkout at a participating retail outlet, the magnetic indicia are read by a dedicated card reader. If the consumer has purchased goods for which a particular type of discount coupon is available, the consumer's bill is automatically credited by the total amount of applicable savings. However, this method does not overcome the foregoing drawbacks, and fails to inform the consumer of which coupons are available before making a purchasing decision. The only consumers whose purchasing decisions are potentially influenced by the available discounts are those who undertake to determine in advance which products are offering a discount via the discount card. This, however, is most likely the same small segment of consumers that are willing to dedicate time searching for and clipping relevant coupons. While this form of purchase incentive may serve to promote the participating retailers, it does not serve as a purchase incentive for specific goods. Thus conventional attempts at overcoming the inconvenience associated with coupon distribution are either ineffective or require the consumer to dedicate an unreasonable amount of investigative time prior to making a purchase in order to locate discounted items.

The explosive growth of the Internet as a means of electronic consumer-based commerce has made the Internet a suitable medium for the targeted distribution of discount coupons to consumers. Consumers are increasingly accessing online resources to conduct purchasing transactions over the World Wide Web. Currently, online advertising and promotion of goods and services are among the most popular uses of the Internet, and the Internet has become an extremely significant advertising tool.

Various methods for online coupon distribution currently implemented on the Internet are disclosed, for example, in U.S. Pat. Nos. 5,761,648, 5,855,007, 5,806,044 and 5,710,886. Some of these methods involve the untargeted serving of printable discount coupons on the basis of a selected geographic location. Other online coupon distribution systems simply provide users with an exhaustive list of available coupons that may be downloaded and printed. These methods of coupon distribution suffer from the same drawbacks of printed coupons in that they require consumers to search through lists of many irrelevant coupons to locate a few pertinent coupons.

Due to the inconvenience of conventional coupon distribution methods and the limited monitoring abilities of conventional coupon distribution systems, it has been difficult to build customer loyalty or to attract new customers through the use of targeted purchase incentives such as discount coupons. Due largely to the inability of current discount coupon distribution services to adequately target discount coupons and promotional materials to interested consumers, use of the Internet for the dissemination of promotional material has essentially resulted in an increased amount of unsolicited junk mail. In other words, the same or similar packages of mostly useless discount coupons and promotional literature received by consumers by mail are being served to the same consumers via Internet resources, such as email facilities, with the same inefficiency.

The advances in wireless communications have enabled the use of mobile devices, such as cellular telephones, as Internet terminals. Not surprisingly, the marketing sector has so far attempted to exploit this relatively new marketing channel for the distribution of coupons, but so far without much success. Consequently, there is a need in the art for a novel comprehensive framework for delivering and redeeming coupons using wireless technology that will solve the problems in the art.

### SUMMARY AND OBJECTS OF THE INVENTION

One object of the present invention is to increase coupon usage percentage. It is another object of the present invention to enable a user-friendly system for distribution and redemption of electronic coupons. It is yet another object of the invention to provide a coupon distribution and redemption system that reduces fraud associated with coupon redemption.

The systems and methods of the present invention achieve these objects by using a wireless network operational within a store or business to deploy and enable the redemption of electronic coupons. The wireless network includes data processing elements, also referred as administration devices, located in the store or business entity and which interact and seamlessly exchange data with a mobile device carried by a consumer or customer. One embodiment of the present invention implements a coupon alert feature whereby a user, as he or she walks around inside a participating store, is alerted about different kinds of electronic coupons available from different product vendors. When alerted, the user may select coupons from at least one of several touch screen devices positioned throughout the store. Information corresponding to the registered user and the selected coupons may either be made available to a point-of-sale (POS) administration device, a POS device (i.e., device for accepting payment and attached to a cash register) or transmitted to the user's mobile device. In another embodiment of the invention, users can select all desired coupons at the beginning of the shopping experience by making coupon selections through a touch screen device in the store.

Bluetooth technology may be used to allow for user registration and user identification at the store such that a main server can associate selected or available coupons with the customer's mobile device. The Bluetooth interface may be used by the POS administration device or POS device to associate the specific mobile device with electronic coupons selected by the user and stored at the main server.

In an alternative embodiment, the Bluetooth interface may be used to download coupon data to the mobile device. In addition, the Bluetooth interface may also be used to transmit coupon data from the mobile device to a POS administration device or POS device connected to the wireless network within the store or business entity.

The system of the present invention may also include data management mechanisms to delete coupons from a customer's mobile device upon the customer redeeming a coupon, leaving the store, turning on the mobile device within the store, or entering the store. The system of the present invention may also encompass a main server that in addition to managing communications in the wireless network of the present invention, also communicates with remote servers to update coupon data, generate and exchange reports, and to clear transactions.

### BRIEF DESCRIPTION OF THE DRAWINGS

FIG. 1 illustrates an overview of a general system for processing electronic coupon data encompassing several aspects of the present invention;

FIG. 2 illustrates an interaction between a user and a display device in a store for coupon selection in accordance with one embodiment of the present invention;

FIG. 3 illustrates a user registration process and components for user registration in accordance with one embodiment of the present invention;

FIG. 4 illustrates electronic coupon selection and acceptance processes by a user and the components used to carry out the processes in accordance with one embodiment of the present invention;

FIG. 5 illustrates a flowchart of a user registration process in accordance with one embodiment of the present invention;

FIG. 6 illustrates electronic coupon creation and distribution processes in accordance with one embodiment of the present invention;

FIG. 7 illustrates a flowchart of an electronic coupon redemption process at a point of sale in accordance with one embodiment of the present invention;

FIG. 8 illustrates the operation flow diagram of a coupon alert system in accordance with one embodiment of the present invention;

FIG. 9 illustrates a flowchart of the coupon data distribution associated with a clearinghouse process in accordance with one embodiment of the present invention;

FIG. 10 illustrates a flowchart of a user registration process via a web server in accordance with one embodiment of the present invention;

FIG. 11 illustrates the flow of data from a business/store data administration device to the display devices in the store that enables the acceptance of electronic coupons in accordance with one embodiment of the present invention;

FIG. 12 illustrates a flowchart of a user communication interface process to connect a device in the wireless network with a central data administration device in accordance with one embodiment of the present invention;

FIG. 13 illustrates a flowchart of the operations of a display device in accordance with one embodiment of the present invention;

FIG. 14 illustrates an electronic coupon display feature triggered by the removal of a product from a bin in accordance with one embodiment of the present invention;

FIG. 15 illustrates a flowchart of the process for downloading and installing software in a mobile device to facilitate electronic coupon redemption and distribution in accordance with one embodiment of the present invention; and

FIG. 16 illustrates a flowchart representing use of a mobile device to redeem coupons in a store in accordance with one embodiment of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

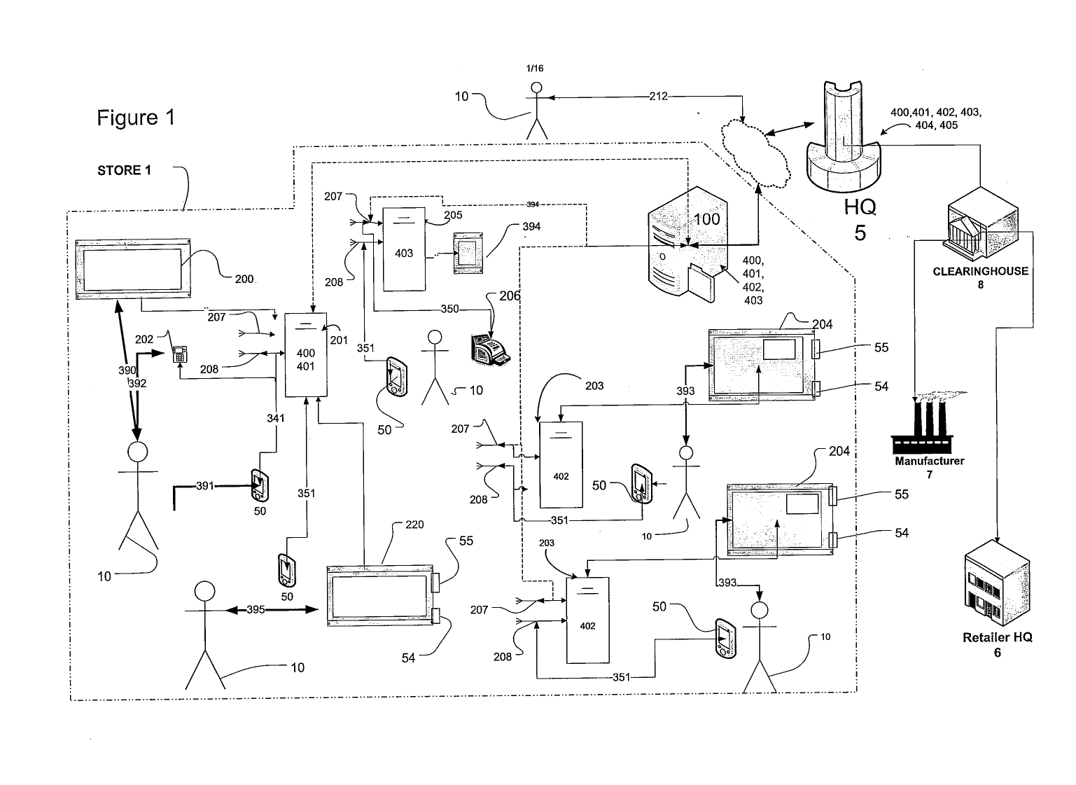

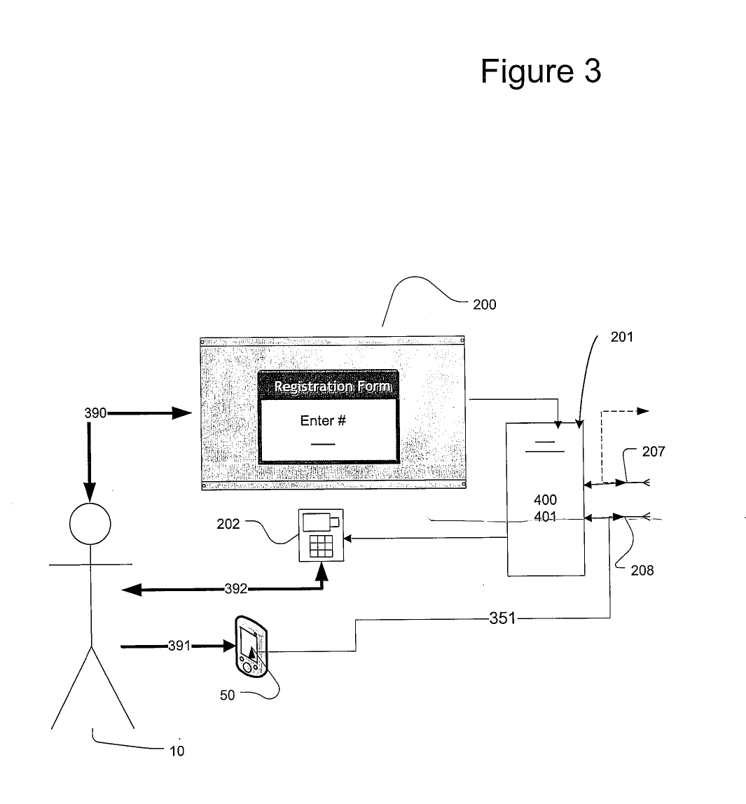

FIG. 1 shows an overview of a general system for processing electronic coupon data encompassing several aspects of the present invention. To benefit from use of the present invention, a user 10 may register such that information identifying a mobile device associated with that user can be stored in a headquarters database 5 and distributed to the main server 100 whenever a registered user enters a store 1. The term “user” is used interchangeably with the terms “customer” and “consumer.” FIG. 3 illustrates a system for user registration in accordance with one embodiment of the present invention. The user registration system is also illustrated in the upper left area in FIG. 1.

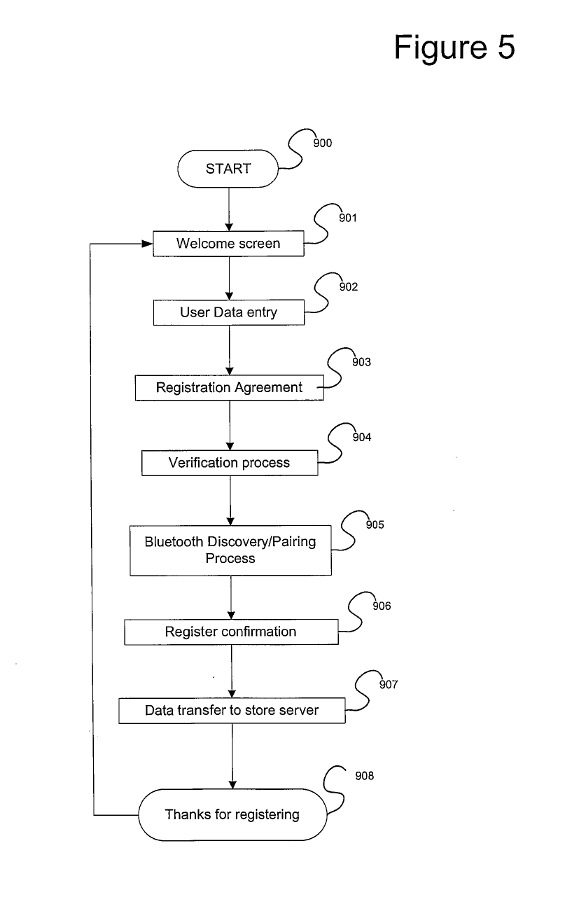

FIG. 3 illustrates a user 10 with mobile device 50 registering in the store 1. The user 10 may interact (390) with a touch screen device 200 to enter information requested by the registration program 400 (illustrated in FIG. 5). Alternatively, the user 10 may interact (392) with a keypad 202 to enter information requested by the registration program 400, which may be displayed on the touch screen device 200 or other display device. In a preferred embodiment the mobile device is Bluetooth-enabled.

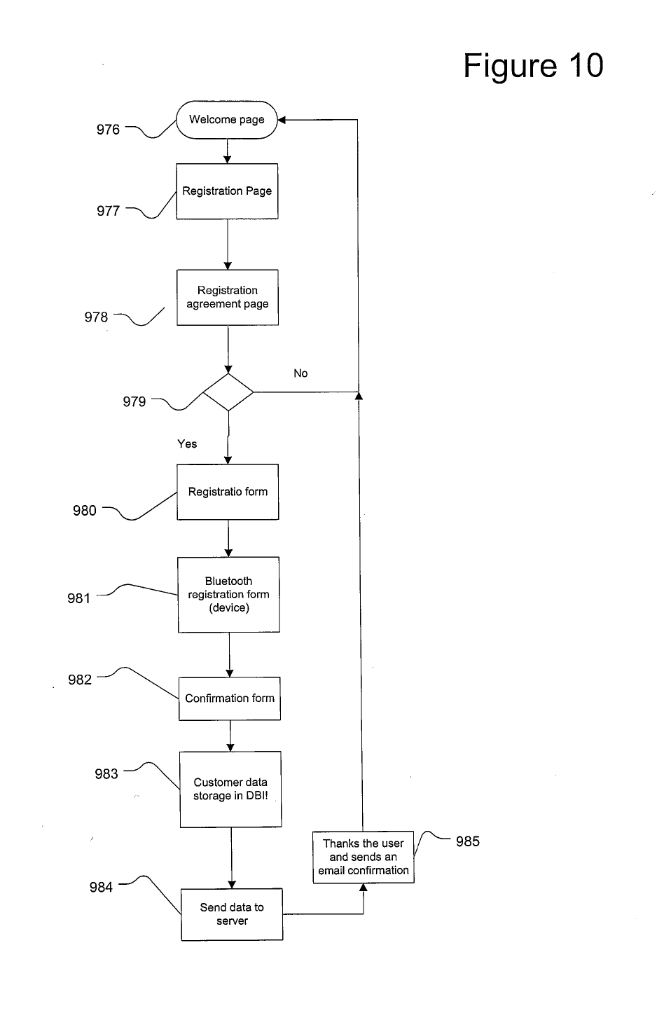

The registration process, explained in more detail with reference to FIG. 5, need only be performed once as long as the user 10 doesn't change the mobile device 50 or performs a web registration 212 (explained with reference to FIG. 10), store impulse, or is otherwise registered. Store impulse may be defined as an in-store booth used to assist in the registration process.

The user registration program may be run by an data administration device 201. Data administration devices (201, 203, 205) may be defined as a general purpose computer programmed to execute instructions that carry out the steps in FIG. 5 as would be appreciated by a person of ordinary skill in the art. It may also be implemented as a micro controller executing instructions stored in an EPROM. Alternatively, the programmed instructions may be hardwired in an FPGA or ASIC such that the hardwired logic implements the steps 900-908 in FIG. 5, as would be understood by a person of ordinary skill in the art.

The touch screen device 200 and the keypad 202 may each separately communicate with the data administration device 201 through a wired connection or by establishing a wireless link with the data administration device 201 through antenna 207, for example. The data administration device 201 may also include a separate antenna 208 for communication with a Bluetooth device. In a preferred embodiment, the user is within Bluetooth communication range of and communicates with the data administration device 201 so that the mobile device 50 is recognized by the data administration device 201 as part of the registration process.

FIG. 5 illustrates an in-store registration process. A registration program 400 running in the data administration device 201 receives an indication from either the key pad 202 or touch screen 200 that a user 10 wishes to initiate the registration process. In one embodiment, upon receiving this indication, the registration program 400 causes the data administration device 201 (a) to establish a wireless network communication through antenna 207 with the in-store main server 100, (b) to send a command to the touch screen 200 to initialize screens, and (3) to allow receipt of registration data from user 10. The data administration device 201 commands the touch screen 200 to display a graphic representation of steps to follow, media, pictures, explanations, videos, registration information, etc., as part of a “Welcome” screen 901. This Welcome screen may be used generally to provide an overview of the system of the present invention to the user 10.

After following directions shown in the Welcome screen 901, the user is prompted to a user data entry process 902. Using the keypad device 202 or the touch screen device 200, the user 10 may enter basic user registration information requested by the system. The user registration information may include the mobile phone number associated with the mobile device 50, user address, credit card information, etc. In an alternative embodiment, the user 10 may also perform the user data entry process 902 through other types of connections to the system database HQ 5 such as internet connection, store impulse, mobile device connection, etc. The system database HQ5 may also be referred to herein as Headquarter servers 5 or Headquarter database 5.

After the data administration device 201 has received the user registration information, it optionally commands the touch screen 200 to display a registry agreement 903. The agreement may include the legal terms, conditions, rules and regulations of use of the system. After receiving an indication that the user has considered the registration agreement, the program 400 in the data administration device 201 executes a verification process, causing the data administration device 201 to query the main server 100 to check the information provided by the user 10 for its existence in the system database. The list of registered users is downloaded by the main server 100 from the HQ servers 5. If the program 400 determines that the user is a new user (e.g., no user information exists in the system), then the information provided is transmitted to the main server 100, which is in turn forwarded to the HQ servers 5 for storage. In the event it is determined that the user is already registered, the data administration device may prompt the user for additional verification to ensure there is no error in the previous verification. Alternatively, the user may register a new mobile device by providing the additional verification after the system has recognized the user as a registered user. If the additional verification process succeeds (i.e., the user is not registered or the user wishes to register a new mobile device), the registration process continues. Otherwise the data administration device 201 causes the touch screen device 200 to display a message that the user has already been registered and is ready to use the system.

In a preferred embodiment the registration process includes a Bluetooth discovery and pairing process 905 in which the program 400 causes the data administration device to communicate with the mobile device 50 through a Bluetooth interface and causes the touch screen device to display instructions that the user can follow to enable the mobile device 50 Bluetooth connection. Bluetooth pairing may be defined as the agreement between two Bluetooth devices to communicate with each other and establish a connection. In order to pair two Bluetooth wireless devices, a password (passkey) maybe be exchanged between the two devices. A Passkey in turn may be defined as a code shared by both Bluetooth devices, which certifies that both users have agreed to pair with each other.

To complete the discovery and pairing process the user 10 may interact 391 with the mobile device to indicate that the data administration devices (e.g., 201, 203, 205) are allowed to communicate with the mobile device 50. After the mobile device's Bluetooth connectivity is enabled the system finalizes the discovery and pairing process, the data administration device 201 retrieves the mobile device's unique Bluetooth ID and saves it, and there is no need for engaging in the discovery process again unless the user desires to register a new mobile device. Once registered, the system of the present invention detects the presence of the mobile telephones in the store but does not require discovery of registered mobile devices.

After the Bluetooth discovery/pairing process 905 is finished, the data administration device 201 commands the touch screen 200 to display a message to the user confirming the successful registration 906. The user registration information is then uploaded 907 to the main server 100, preferably using an encrypted wired or wireless network connection. In one embodiment of the present invention the program 400 then automatically returns to step 901.

FIG. 10 illustrates a flowchart of a user registration process via a web server in accordance with one embodiment of the present invention. In this embodiment, users may register through the Internet. In one implementation of this embodiment the HQ server 5 may send javascript code to the user's computer to display information to the user so that he or she can navigate through the web registration process.

The first step may be displaying a Welcome screen 976 on the device used by the user to connect to the HQ server and database 5. Next, registration information may be displayed 977 at the user's device or web-enabled computer. In step 978 the user device or computer may display a registration agreement. The registration agreement page may include a user acceptance button (step 979) whereby the user is given the option to accept the registration agreement. Upon receipt of an indication of acceptance of the terms, HQ server may instruct the user computer or device to display a registration form 980 which accepts user input of information required for registration. If the user does not accept the terms of the agreement, the user device or computer may display the ‘Welcome’ screen again. In an alternative embodiment the user agreement step is skipped.

After filling the registration form 980 the user 10 is guided step by step to register a Bluetooth enabled mobile device 50 and insert into the form the unique mobile device Id (e.g., Bluetooth Id) to be used for in-store coupon redemption (step 981). A confirmation screen is shown if the mobile device is successfully registered Step 982.

The user registration information is stored in HQ database 5 (step 983). The registration data is sent to the general data administration devices 100 (step 984). The user's Internet terminal screen displays a “Thanks for registering” message and the program optionally sends a confirmation email to an email address provided by the user 10 in step 980 (step 985).

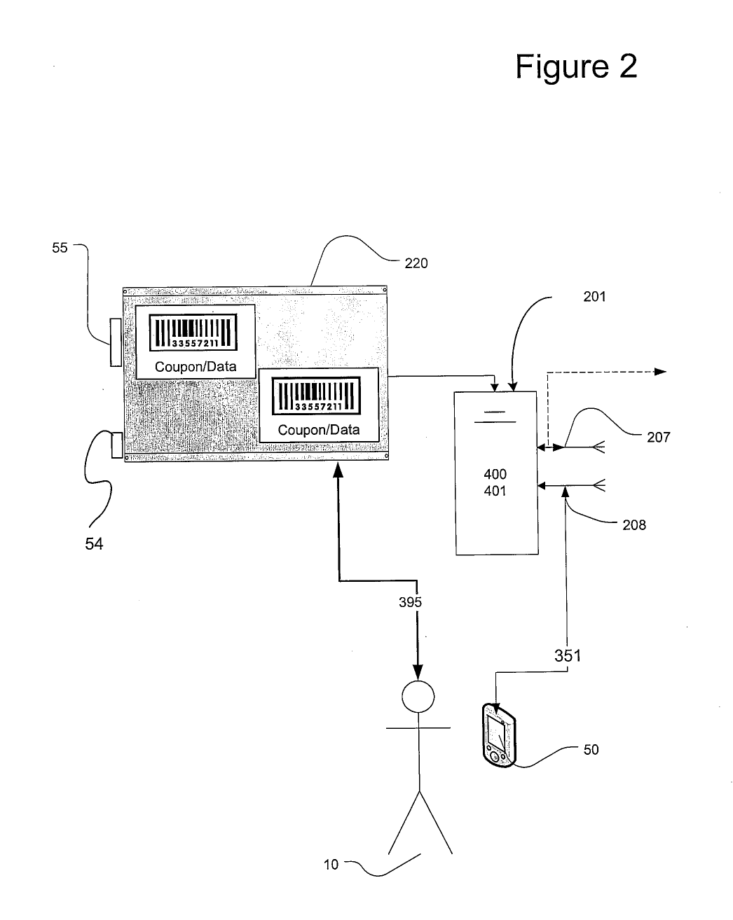

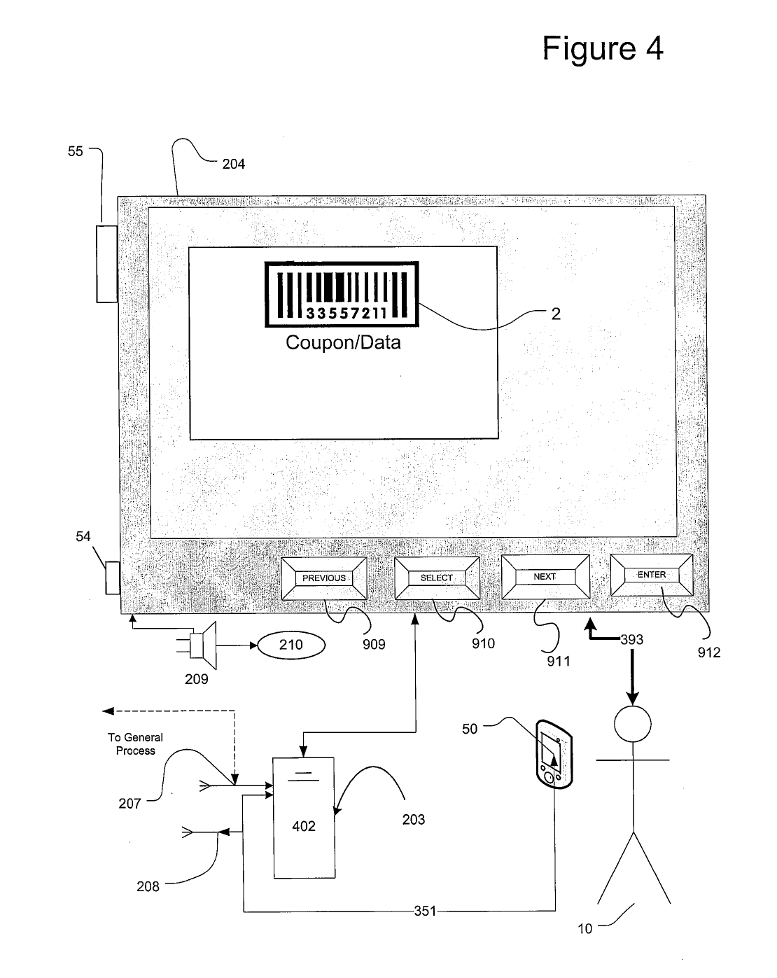

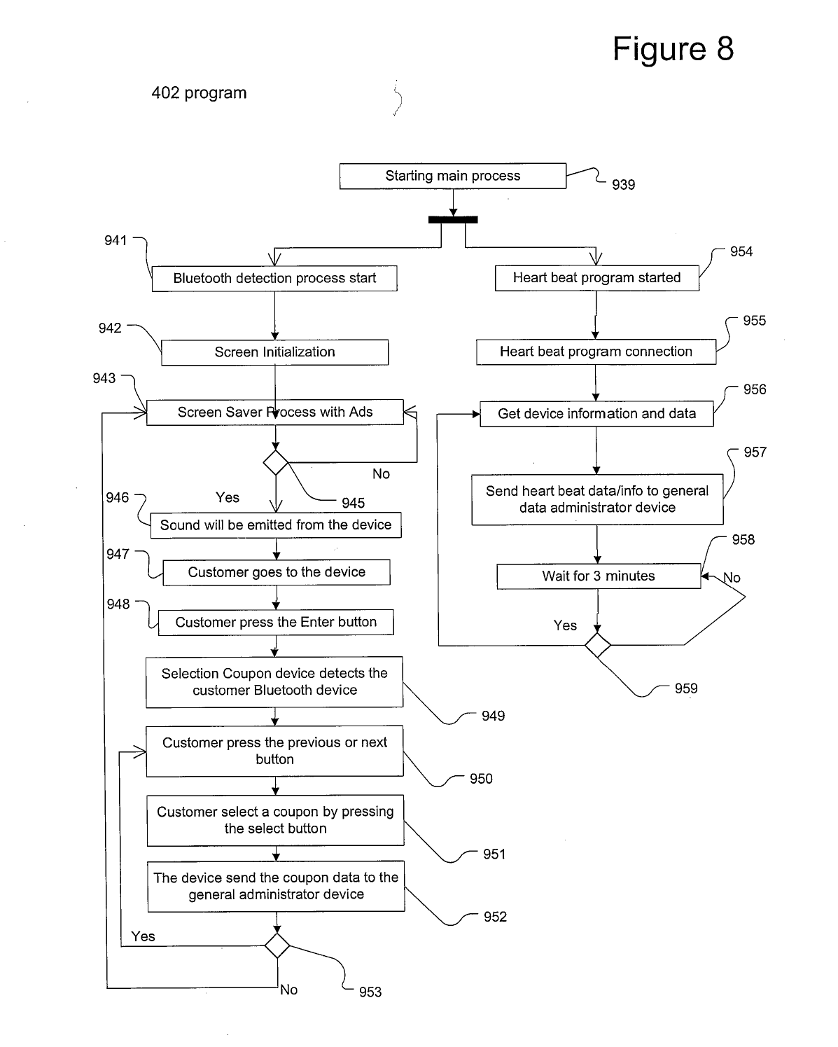

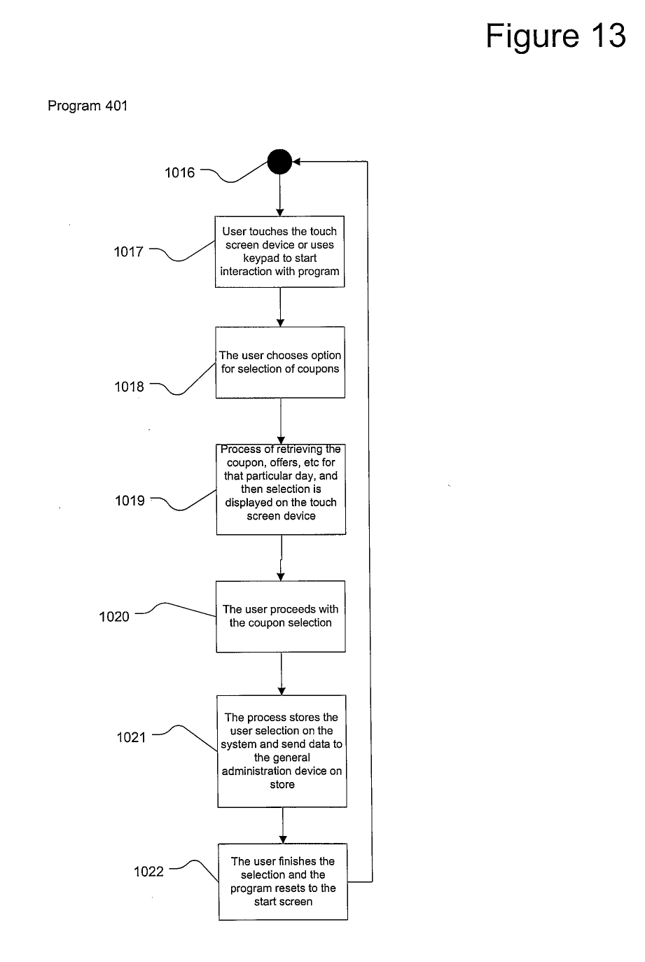

Once registered, a user 10 may make coupon selections 395 before beginning to shop (FIG. 2 and FIG. 13) or as the user 10 strolls throughout the store (FIG. 4 and FIG. 8).

FIG. 2 illustrates an interaction between a user 10 and a touch screen device in a store. Specifically, through use of the touch screen device 220 located in the store, the user 10 is able to pre-select (395) the coupons to be used before the user 10 begins to shop. Alternatively, this embodiment can also be used after the user has picked up the articles to purchase, but desires to select coupons at once instead of making the coupon selection as the user strolls around the store (FIG. 4 and FIG. 8). The touch screen device 220 establishes a wired or wireless connection to data administration device 201 to communicate image, coupon data, etc.

In addition to running a program 400 for registering users, the data administration device 201 of FIG. 2 may run a program 401 for selection of electronic coupons. Program 401, illustrated in FIG. 13, may exchange information with the mobile device 50 through a communications link 351, e.g., through a Bluetooth interface. The program identifies the registered mobile device 50 and activates the electronic coupons available for the specific store 1 after user selection. Alternatively, the touchscreen device 220 may include a magnetice strip reader 54 for user identification or an RFID reader for either user identification or for detection of removal of a product from a bin in other embodiments of the present invention. The user 10 may select the preferred coupons for the day, so any further interaction with other devices (e.g., 203) in the process can be skipped until reaching the payment point 206. The payment point may also be referred herein as the POS location.

FIG. 13 illustrates the flow diagram of the program 401 for user selection of coupons in accordance with one embodiment. Step 1016 represents the beginning of the program, which may simply refer to a touch screen device in a ready state for user input. The user may initiate the coupon selection process (step 1017) by touching the touch screen device or a keypad (not illustrated in FIG. 2). The touch screen displays to the user 10 an option to initiate the coupon selection process. The program 401 accepts the user selection of the option (step 1018). Step 1018 is followed by a process in program 401 to retrieve electronic coupons, offers, offers, etc., available on that particular day and the list of available coupons is then displayed on the touch screen device 220 (step 1019). The user 10 selects the desired coupons (step 1020) and the selection, along with user or mobile device identification, time, and date information, is transmitted and stored (step 1021) in the main sever 100. The user 10 indicates that he or she has completed the selection process and the program 401 resets to the start screen (step 1022). In a preferred embodiment, the coupon selections by users and the user information are not stored in the data administration devices in order to avoid fraud.

In another embodiment of the present invention, users select electronic coupons as they stroll around the store (FIG. 4 and FIG. 8). FIG. 4 illustrates electronic coupon selection and acceptance processes according to this embodiment. The elements illustrated in FIG. 4 appear twice in FIG. 1 (on the bottom right portion) to show two aisles in a store and how the similar or identical devices 203a and 203b are each placed in a separate aisle.

Referring to FIG. 4, a registered user 10 may begin the shopping process in the store 1 by walking around aisles in the store. A user may interact 393 with devices 204, which are located throughout the store and are connected through a wired or wireless connection with the data administration devices 203. These devices 203 may be equipped with a wireless antenna 207 and a Bluetooth antenna 208, and they run an electronic coupon selection program 402 (FIG. 8). The devices 203 may identify the mobile device 50 of the user 10 through a Bluetooth detection process 351. A Bluetooth detection process may be defined as the detection of the presence of a Bluetooth device or Bluetooth-enabled mobile device. At that point a electronic coupon 2 data selection program 402 (FIG. 8) running in the data administration device 203 may generate an alert sound 210 from the display device speaker 209 to direct the user's attention to the display device 204, where the user can see and select the electronic coupons, offers, promotions, etc. The user 10 may browse through available coupons by pressing a previous button 909 and the next button 911. The display 204 may be implemented as a conventional point-of-sale device (with or without the capability for accepting payment) with capability of receiving input through touch screen, keypad, or combination of both.

As the user browses available electronic coupons, the user may press the select button 910 to mark coupons as being selected. After the user 10 selects the desired electronic coupon(s) the user may move on to the next aisle and continue the shopping experience. At the next aisle the user may encounter the same setup for coupon selection, as illustrated in FIG. 4. The selection collected from the user 10 is then transmitted by the data administration device 203 via wired or wireless network to the general data administration device 100 in the store 1. In one embodiment, the coupons presented to the user correspond to products displayed on the aisle where display device 204 sits.

FIG. 8 illustrates the operation flow diagram of the alert process and the coupon selection process implemented by the system illustrated in FIG. 4 as steps of program 402 (FIG. 8). Program 402 may run in the data administration devices 203.

Step 939 indicates initiation of the main program 402. A parallel operation of tasks may be carried out by the program 402. The first operation, described with reference to steps 941-953, relates to detection of the mobile device 50 and user selection of electronic coupons. The second operation, described with reference to steps 954-959, relates to alerting the main server 100 when the device running the program 402 is not properly operating.

In step 941 the data administration device 203 obtains an ID corresponding to the user mobile device 50 through a Bluetooth detection process, for example. In step 942 display device screen initializes, and a screen saver with ads launches (step 943). A conditioning part of the program 945 determines if the discovered ID of the mobile device 50 belongs to a registered user. If the presence of a registered user is confirmed, speaker 209 emits a sound alert 210, which is intended to direct the user's attention to the screensaver displaying ads (step 946). The user 10 may decide to approach the display device 204 (step 947). After the user initiates interaction with the display device (step 948), for example by pressing a button 912, the aisle data administrator device 203 may initiate another ID detection process to re-confirm that the user has been registered. Upon re-confirmation or after the interaction with the display device, the display device 204 may show the user a list of users whose mobile devices have been detected in the aisle. After the user confirms his or her identity, the aisle data administrator device (e.g., 203b) retrieves the user's data from the main server 100 (step 949). The user 10 may continue to interact with the display device 204, for example, by pressing “next” button 911 or “previous” button 909 to browse available coupons (step 950). In step 951 the user 10 selects the electronic coupon 2, offer, etc. The coupon selection data is sent to the general data administrator 100 (step 952). A conditioning part of the program 953 determines if the user 10 will continue using the program 402 and either takes the user 10 back to step 950 or returns to screen saver process 943.

Steps 954-959 implement a heartbeat program which runs in parallel with steps 941-953 in accordance with one embodiment of the present invention. A heart beat program may be defined as a computer process that identifies the status of a device within the system network. Step 954 includes initialization of the heart beat program. Step 955 includes establishing a connection with the main server 100 (also referred herein as general data administration device, general data administration device, or central administration device). After the heartbeat connection between the device 203 and the main server 100 is established, the data administration device 203 retrieves information identifying the device (step 956) and a heartbeat message and device identification information are sent to the general data administration device 100 (step 957). In one embodiment, the heartbeat program waits for a period of three (3) minutes (step 958) before transmitting heartbeat and device identification information to the main server 100. The part of the program that conditions the time delay period is represented in step 959. After the specified delay time expires, the program returns to step 956. The three minute wait period is exemplary and it can be changed in accordance with the system designer specifications.

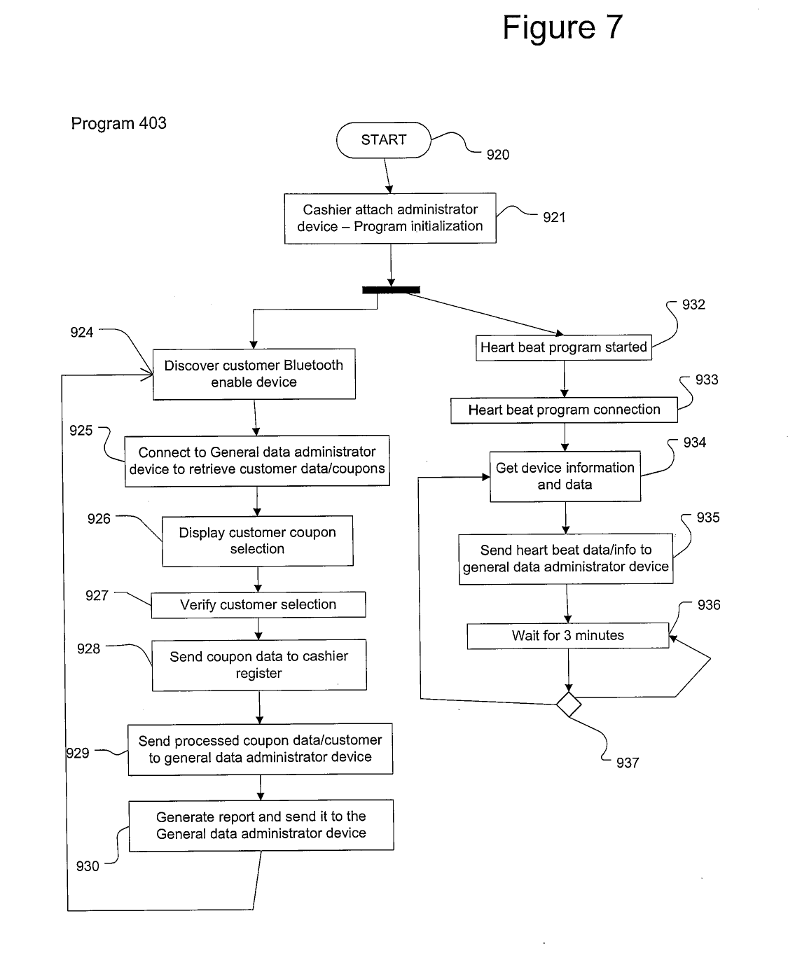

Referring to FIG. 1, once the user 10 finishes shopping, the user 10 goes to the payment point 206. The payment point 206 may be defined as a Bluetooth enabled point-of-sale device connected to a POS administration device 205 equipped with a wireless antenna 207 and a Bluetooth antenna 208. The POS administration device 205 runs an electronic coupon redemption program 403 (FIG. 7). When the POS administration device 205 identifies the Bluetooth enabled mobile device at the payment point, it retrieves from the main server 100 the electronic coupon data associated with the device. This coupon data may be a bar code, scanned coupon, or other code sufficient for the redemption of the coupon.

In the embodiment where the POS administrative device 205 connects to a touch screen device, the user 10 finishes the buying process by generating an interaction 394, between the POS device 206 and the POS administration device 205 based on the data the user 10 entered through the touch screen device. This data is then transmitted via wired or wireless connection to the general data administrator 100.

FIG. 7 illustrates the flow diagram for electronic coupon data redemption process at the point-of-sale 206 in store 1. The process may be implemented as a sequence of steps that may be performed by the point-of-sale device 206, the POS administration device 205, or both, depending on whether the store owner allows communications or software access to its point-of-sale device 206. The combination of steps is referred to herein as computer program 403, even though the steps may be split between a program running in the point-of-sale 206 and the POS administration device 205.

Step 920 denotes the start of the program. Step 921 includes initialization of POS administration device 205. The POS administration device 205 may wirelessly connect to the point-of-sale device 206. In parallel the program may run two tasks. The first task relates to connecting the POS administration device 205 to the general data administrator 100 via wired or wireless connection to retrieve all current data corresponding to a user at the payment point. This first task is described with reference to steps 924-930. The POS administration device 205 detects the mobile device 50 (e.g., via Bluetooth) in step 924. Alternatively, the POS administration device 205 verifies user identification by reading a magnetic strip from a key job presented by the user. In step 925 the POS administration device 205 uses the mobile device ID (user ID) to retrieve coupon selection data corresponding to the registered user. The POS administration device 205 may be implemented as data administration devices 201 and 203 or as administration devices 201 and 203 modified to include a display device. Customer data and current selection of coupons may optionally be displayed by a touch screen device connected to the POS administration device 205 (step 926). If the POS administration device 205 cannot communicate with the point-of-sale device 206 (for example, when store owner does not allow access), the cashier may use a scanner to scan the coupon information displayed on the POS administration device 205. In step 927 the customer may optionally verify the coupon selection at the POS. Step 928 includes sending the coupon data from the POS administration device 205 to the point of sale device 206. For example, this may be done through a wireless connection. Alternatively, the coupons may be scanned by a device connected to the point-of-sale device 206.

Step 929 includes sending redeemed coupon and customer data from the point-of-sale device 206 to the general data administration device 100. Optionally, the redeemed coupon data may be stored for a number of customers, organized in a report, and then sent to the general data administration device 100 (step 930).

The second task ran by the data administration device to steps 932-937. In step 932 the POS administration device 205 initiates a heartbeat program. Step 933 includes establishing a connection with the main server 100. After the heartbeat connection between the device 205 and the main server 100 is established, the POS administration device 205 retrieves information identifying the device (step 934) and the heartbeat message and device identification information are sent to the general data administration device 100 (step 935). In one embodiment the heartbeat program waits for a period of three (3) minutes (step 936) before transmitting heartbeat and device identification information to the main server 100. The part of the program that conditions the time delay period is represented in step 937. After the specified delay time expires, the program returns to step 934. The three minute wait period is exemplary and it can be changed per the system designer specifications.

After redemption of the coupons at the payment point 206, the general data administration device 100 may transmit to the Headquarter servers 5 in real time through the wireless connection network all the registration data gathered by use of program 400, all the selection data gathered by program 401, all the selection data gathered by program 402, and all the redemption data gathered by program 403. The headquarter servers 5, additionally receive all the user registrations and updates that users perform via web servers, store impulse, or other types of device connections.

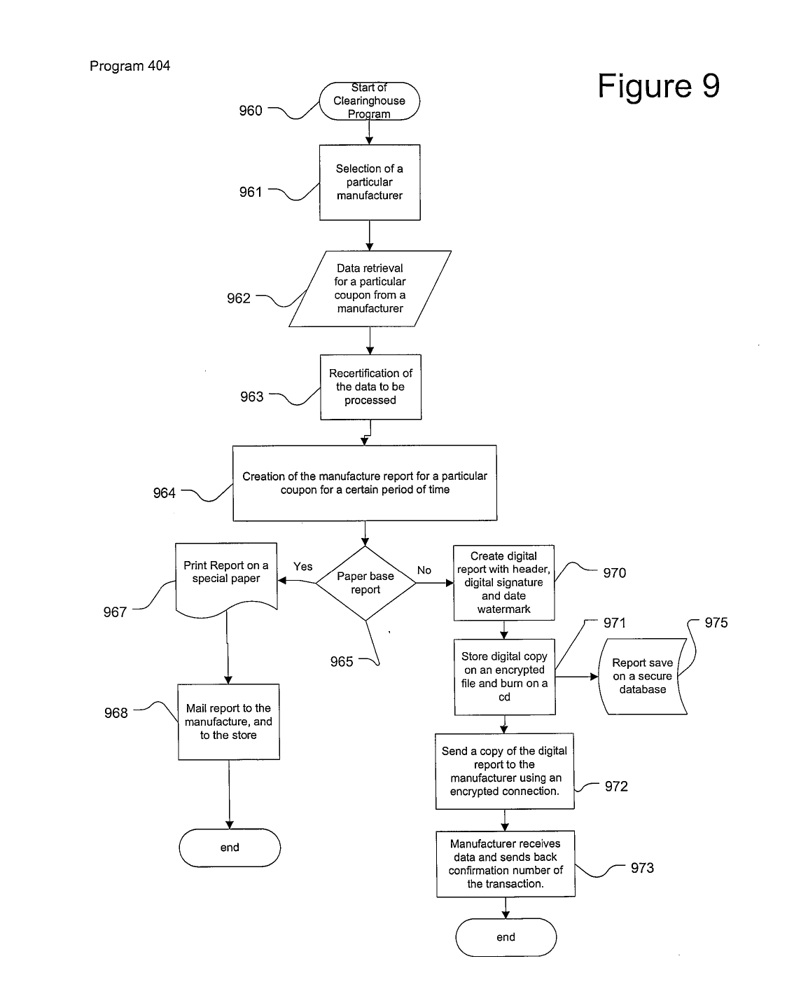

The headquarter servers 5 feed the electronic coupons 2 data, offers, discounts, images, messages, etc., to the general data administrator 100 which then feeds all the electronic data to devices 201-203 and 205. The headquarter servers 5, through a redeemed electronic coupon program 404 (FIG. 9), organizes all the redemption data gathered and sends the data performing the clearinghouse 8 task generation and the necessary reports to the Manufacturers 7 and the retailers headquarters 6. These reports may include, for example, data corresponding to coupons that have been selected, redeemed and paid for by the users.

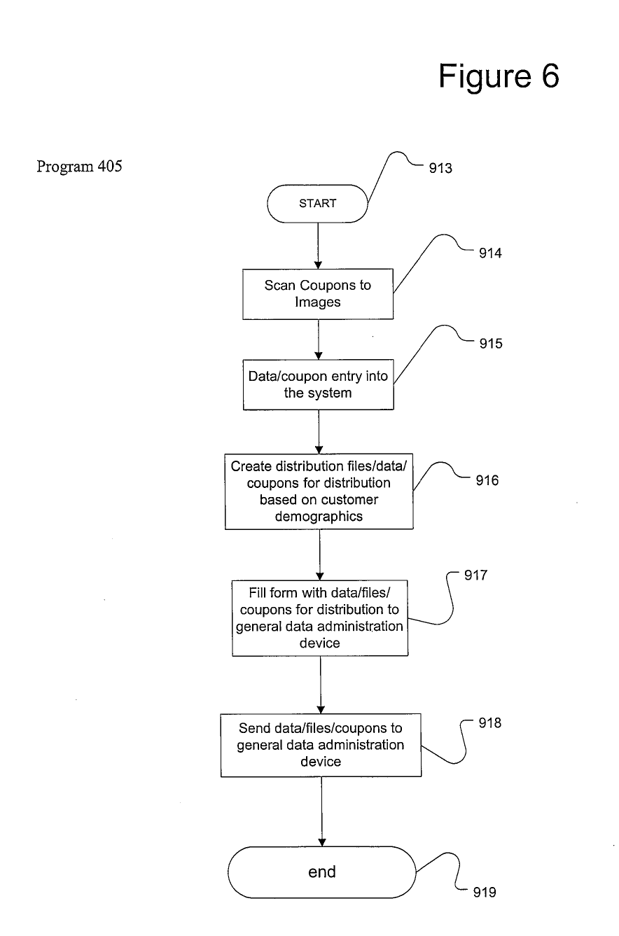

FIG. 6 illustrates the electronic coupon 2 data creation process and coupon data distribution to data storage and administration components of the stores. The process is performed by a program 405 (FIG. 6) which may run in HQ servers 5. Step 913 includes initialization of the program 405. Physical coupons may be scanned and converted to images (914). These images can be presented to users in the store after distribution to the main server 100 and ultimately display devices 200, 220, and 204, for example.

In addition to scanning physical coupons, the system of the present invention preferably uploads digital coupon data to the HQ servers 5. Step 915 includes entering data corresponding to electronic coupons into a database residing in the HQ servers 5 (step 915). The system then gathers all the information entered and creates distribution files, data and coupons packages based on store/city/county/state (step 916). HTML fulfillment forms with data, files, coupons, etc., are filled out for distribution of the coupon data, promotions, etc., to the general data administration devices 100 (step 917). The forms may be filled out considering the customer demographics. For example, if customers in a given geographical area are known to consume large quantities of grits, then coupons for instant grits products may be distributed to main servers (100) in stores located in that geographical area, but not necessarily distributed to stores in a geographic area where grits are not so popular with customers. The data, files, coupons, etc., are then transmitted (918) to the General data administration devices 100 according to the coupon fulfillment forms. Step 919 denotes the end of the electronic coupon creation and distribution program 405.

FIG. 9 illustrates the flow diagram of a clearinghouse process that may be implemented in the HQ servers 5 or in clearinghouse 8. The clearinghouse may be defined as a virtual enterprise within the HQ servers 5 which organizes all redeemed coupons and sends reports to Retailer Headquarters 6 and manufacturers 7. In turn, the steps may be implemented as a computer program 404. Step 960 includes initialization of the clearinghouse program 404. Step 961 includes selection of a particular manufacturer (7) that issues coupons. Step 962 includes retrieval of coupon redemption data for the particular manufacturer. The coupon redemption data may include the coupon value, coupon expiration date, coupon redemption date, information about user that redeemed the coupon, etc. Optional step 963 includes recertification of data to be further processed. Step 963 may be implemented as an audit of the coupon data, for example, by checking that the coupon was redeemed before its expiration date. Step 964 may include the creation of a report for the redemption of a particular coupon for a specific period of time. For example, the coupon may be for a six-pack of soda cans for $3.00, redeemed over a specified time period.

A conditioning part of the program 404 determines if a paper report will be generated (step 965). If a paper report is to be generated, the report is printed in a special security paper (step 967). The security paper may be defined as paper incorporating hidden message technology so that when it is copied it reveals a message such as “not original.” Step 968 need not be implemented as part of program 404. Step 968 includes mailing the printed report to the manufacturer 7 and the Retailer HQ 6.

If no paper report is to be generated, step 970 generates a digital report that may include header information, digital signature and date watermark. The digital report is encrypted and optionally stored in a portable medium such as a CD-ROM (step 971) and storing the report in a secure database (step 975). Step 972 includes transmitting to the manufacturer 7 a copy of the encrypted report. The report may also be sent to the Retailer HQ 6. Step 973 includes the receipt of confirmation that the report has been received by the manufacturer 7.

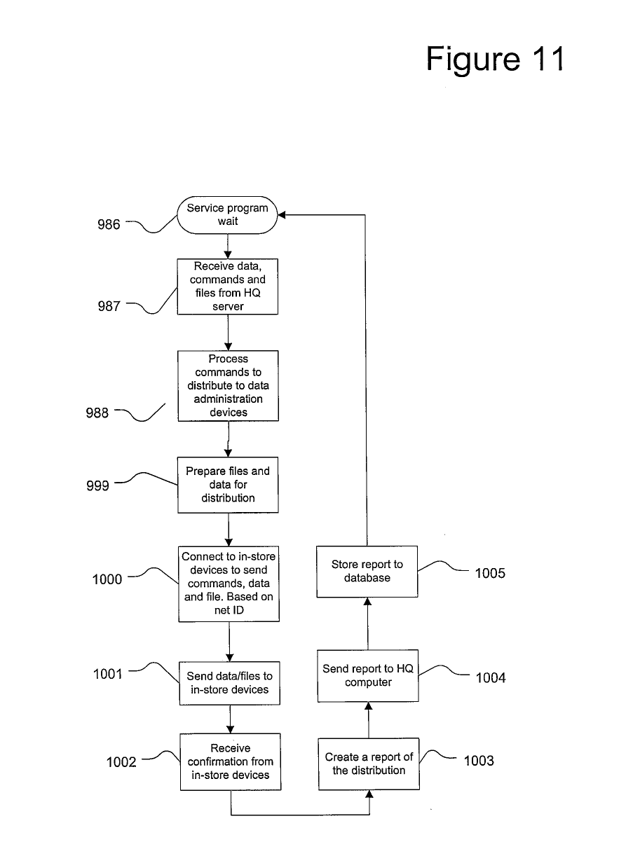

FIG. 11 illustrates the process of distributing coupon data from the main server 100 to data administration devices in a store (e.g., 201, 203, and 205) that allows for the acceptance of the electronic coupon data, messages, discounts, etc. The process in FIG. 11 may be implemented as a computer program running in the main server 100. Step 986 denotes a wait state of the distribution program. Step 987 includes receiving coupon and user information from HQ 5. Step 987 may also include receiving commands from the HQ server 5 with instructions on how to distribute the coupon information downstream to the data administration device. Step 988 includes processing commands (either received from HQ 5 or pre-configured) to distribute user and coupon data to the data administration devices. The user information or data may include, for example, mobile device identification information.

Once the command has been processed, user and coupon files and data are prepared for distribution (step 999). For example, step 999 may include partitioning a large file received from HQ servers 5 and sending subsets of the information according to, for example, location of data administration device in relation to a given product. For example, coupon data related to “grits” may be sent only to data administration devices located in a store aisle displaying grits.

Step 1000 includes establishing a communications connection (wired or wireless) from the main server 100 to at least one in-store data administration device (201, 203, or 205). Step 1001 includes transmitting commands and user and coupon data and files based on the network id of the data administration device. Step 1002 includes receiving confirmation that the commands and data has been received by the at least one data administration device.

Step 1003 includes creating a report of the commands and data distributed to the data administration devices 201, 203, and 205). Step 1004 includes sending the report to the HQ servers 5. Step 1005 may be implemented by the HQ servers 5 and it includes storing the reports in a database.

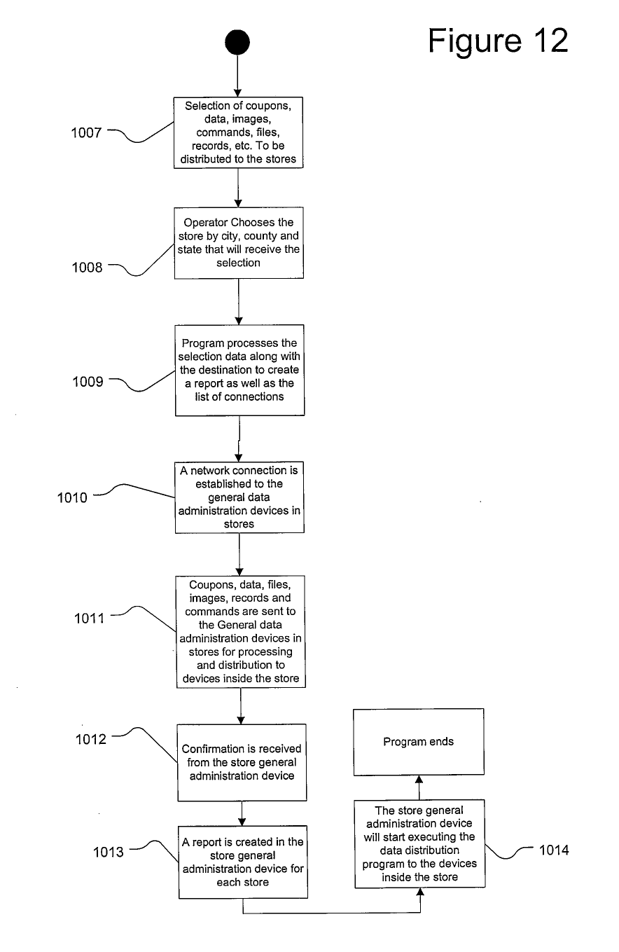

FIG. 12 illustrates the process of entering coupon data for distribution to the general data administration devices 100. Step 1007 includes gathering selection of electronic coupons, data, images, commands, files, records, etc. to be distributed to the stores 1. An operator may choose a particular store or stores to receive the selection gathered in step 1007 by city, county and state (step 1008). The operator may select the stores based on customer demographics.

The Program processes the selection data along with the destination to create a report as well as the list of connections (Step 1009). Step 1010 includes establishing a communications connection with a general data administration device 100. Step 1011 includes transmitting over the communications connection the electronic coupons, data, files, images, records and commands to the general data administration device 100 in store 1. Step 1012 includes receiving confirmation that the main server 100 has received the data sent in step 1011. Step 1013 includes creating a report in the store general data administration device 100. Step 1014 includes execution of in-store distribution of commands and user and coupon data and files to the data administration devices 201, 203 and 205.

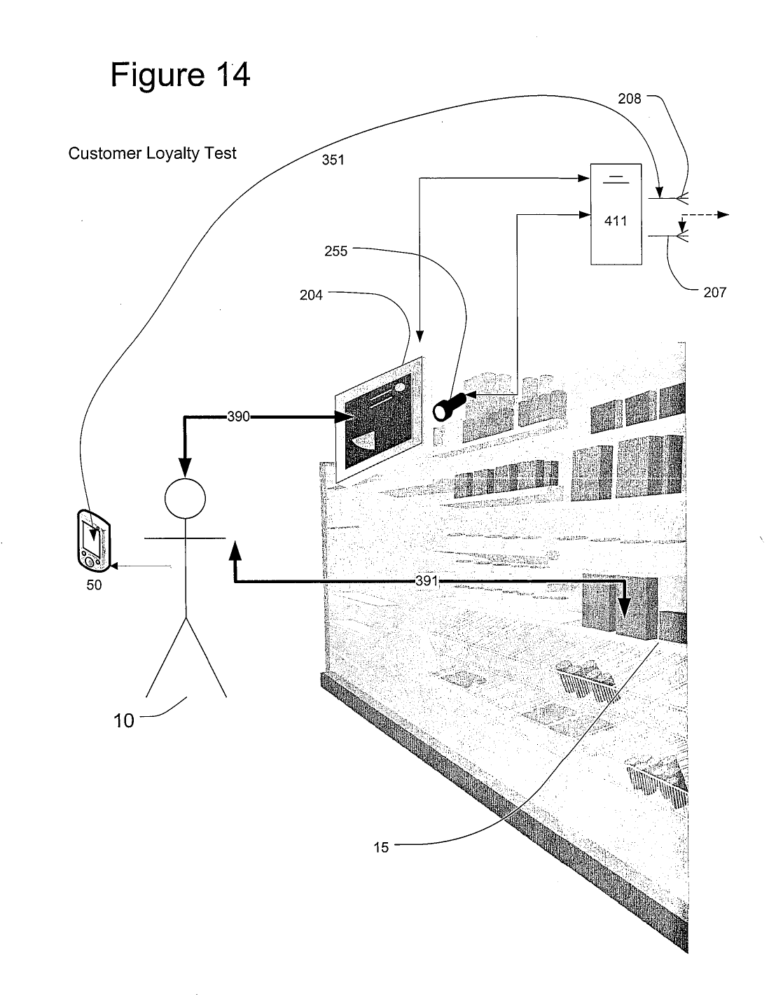

FIG. 14 illustrates a flowchart of an electronic coupon display feature in accordance with one embodiment of the present invention. In the embodiment, the system detects that the user has grabbed a product of a certain brand, for example, brand X cereal. Upon detection, the display shows the user an offer for a competing product, for example brand Y cereal. If the user decides to grab the product displayed, the system detects the removal of brand Y cereal from the aisle bin, detects the mobile device ID associated with the user, and uploads the user and coupon information to the main server 100. The system may also detect whether the user returns the original product (e.g., brand X cereal) to the bin. In the event that the user does not return the original product to the bin, any coupons available associated with that product are also uploaded to the main server 100 together with the user information.

Referring to FIG. 14, a touch screen 204 may display images with promotional or advertisement information. The user 10 with a Bluetooth-enabled mobile device may walk toward a shell to get product 15. When the user 10 grabs the product 15, the RFID sensor 255 senses the product removal, and the program 411 activates the screen 204. The screen 204 may show the user 10 different offers of a product. The user may select one of the products displayed on the screen by simply grabbing the product from the bin. When the system detects the removal of the advertised product from the bin, the program 411 commands the detection of the Bluetooth id from the Bluetooth-enabled mobile device 10, sends the a record with user and coupon identification data through wireless net 207 to the main server 100 in the store.

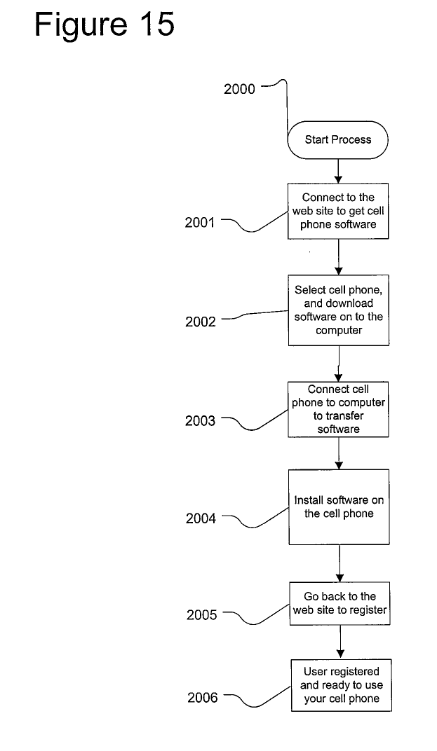

FIG. 15 illustrates a flowchart of the process for downloading and installing software in a mobile device to facilitate electronic coupon redemption and distribution in accordance with one embodiment of the present invention. Step 2001 includes a user computer connecting to a website to download the coupon redemption application to a mobile device. Step 2002 includes selection of a mobile device model and the downloading of the software version corresponding to that model. Step 2003 includes connecting the user mobile device to the user computer to transfer to the mobile device the downloaded software. Step 2004 includes installing the software on the mobile device. Step 2005 includes registration of the mobile device through the web server (see FIG. 10). In step 2006 the user finishes the registration process and is ready to use the mobile device to receive electronic coupons.

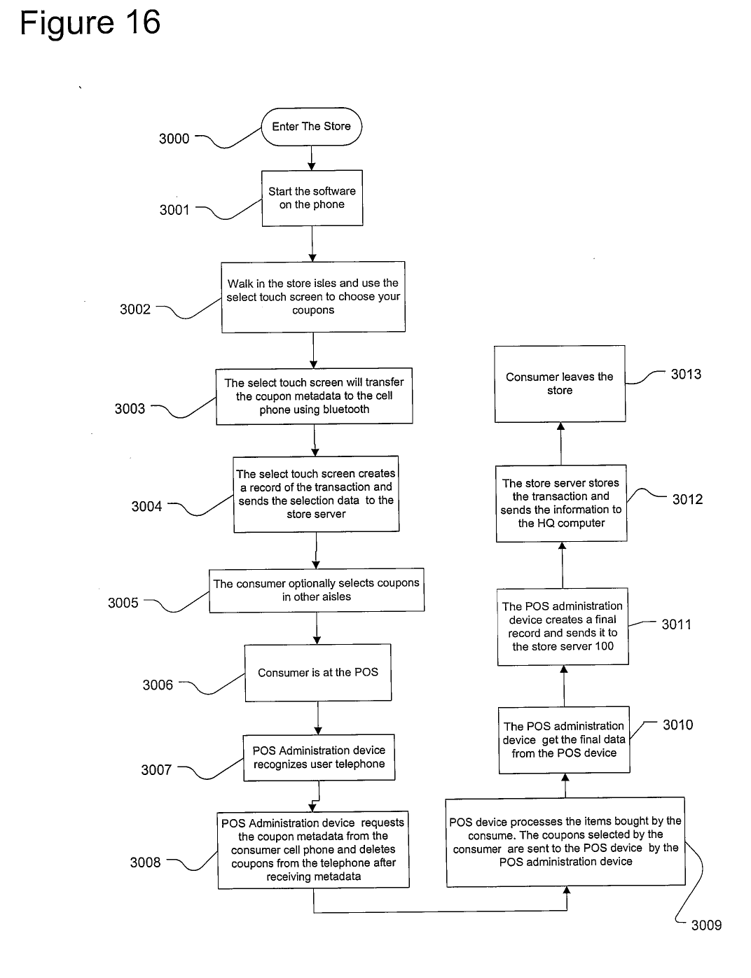

FIG. 16 illustrates a flowchart representing use of a mobile device to redeem coupons in a store in accordance with one embodiment of the present invention. Step 3000 includes detection of the mobile device (e.g., Bluetooth detection) as the user 10 enters the store. Step 3001 includes initialization of software downloaded in step 2004 (FIG. 15). Step 3002 includes selection of coupons by interacting with touchscreens (e.g., touchscreen devices 204). Step 3003 includes transfer of metadata corresponding to coupon selection to the mobile device 50, for example, through a Bluetooth interface. The transfer may be triggered through user interaction with the touchscreen.

Step 3004 includes the creation of a record of the coupon selection and the transfer of metadata and the transmission of the record to the main server 100. In step 3005 the user 10 optionally selects coupons from touchscreen devices in other aisles, where step 3004 would be repeated.

Step 3006 denotes the arrival of the user at the POS location. In step 3007 the POS administration device recognizes the user's mobile device 50. In step 3008 the POS administration device requests coupon metadata from the user's mobile device 50 and deletes corresponding coupon information from the mobile device after receiving the metadata.

In step 3009 the POS device processes the items bought by the consumer and the selected coupons are sent to the POS device by the POS administration device. In step 3010 the POS administration device obtains the final data from the POS device. The final data may be defined as the redeemed coupon data. Step 3011 includes the creation of a final record of the coupon redemption transaction and transmits the record to the main server 100. In step 3012 the main server 100 stores the transaction and sends the information to the HQ servers 5. Step 3013 denotes the consumer leaving the store.

Other embodiments of the invention will be apparent to those skilled in the art from consideration of the specification and practice of the invention disclosed herein. For example, verification of user identification may be carried out by reading a magnetic strip presented or swiped by the user instead of by detecting a mobile device id. Also, coupon images may be presented at the point of sale when the point-of-sale device cannot connect with other elements capable of storing coupon data. It is thus intended that the specification and examples be considered as exemplary only, with a true scope and spirit of the invention being indicated by the following claims.

What is claimed is:

1. A method for processing electronic coupons comprising the steps of:
accepting a selection by a registered user of an electronic coupon associated with a particular product;
creating a record including data identifying said registered user and the selected electronic coupon; and
transmitting said record to a main server.

2. The method of claim 1, further comprising the steps of:
detecting a mobile device identification associated with the user; and
verifying user registration based on the mobile device identification;
wherein the step of creating a record further comprises using the mobile device identification as the data identifying said registered user.

3. The method of claim 2, wherein the step of detecting a mobile device identification comprises receiving over a Bluetooth interface a code identifying the mobile device.

4. The method of claim 1, wherein the selection by a registered user is entered through a touch screen device in a store.

5. The method of claim 1, wherein the step of creating a record is carried out by a data administration device in a store.

6. The method of claim 5, wherein said data administration device is adapted to include a wireless Bluetooth interface.

7. The method of claim 2, further comprising the step of alerting the registered user through an audible sound emitted after the mobile device identification has been detected.

8. The method of claim 1, further comprising the steps of placing a display device in an aisle within a store and displaying an image corresponding to an electronic coupon for a product in that aisle.

9. The method of claim 1, further comprising the step of receiving user registration information, including receiving mobile device identification information through a Bluetooth discovery process.

10. A method for processing electronic coupons comprising the steps of:
accepting a selection by a registered user of an electronic coupon associated with a particular product;
creating a record including data identifying said registered user and the selected electronic coupon; and
transmitting said record to a mobile device corresponding to the registered user.

11. The method of claim 10, wherein the step of transmitting said record to a mobile device comprises transmitting the record over a Bluetooth interface.

12. A method for processing electronic coupons comprising the steps of:
verifying the identification of a registered user at a point-of-sale;
retrieving from a store server data corresponding to an electronic coupon pre-selected by the registered user; and
redeeming the pre-selected coupon if a particular product is presented at the point-of-sale.

13. The method of claim 12, wherein the step of verifying the identification of a registered user comprises at least one of the following:
detecting identification information from a mobile device corresponding to the user;
reading an identification from an RFID tag; or
reading identification information from a magnetic strip.

14. The method of claim 12, wherein the step of redeeming the selected coupon comprises at least one of the following:
retrieving a record with coupon and customer data from a data administration device;
scanning a coupon displayed on an data administration device; or
scanning a coupon displayed on a mobile device corresponding to the user.

15. A method for processing electronic coupons comprising the steps of:
creating coupon data files for distribution to a plurality of remote computing devices in a store;
creating a subset of the coupon data files based on predetermined criteria;
transmitting said subset of the coupon data files to at least one remote server in a store;
receiving from the at least one remote server a report of electronic coupon redemptions per customer;
reorganizing data in the report based on the manufacturer of products associated with redeemed coupons; and
creating a report of coupon redemptions per manufacturer.

16. The method of claim 15, wherein said predetermined criteria comprises consumer demographics.

17. The method of claim 15, further comprising printing the report on special security paper.

18. The method of claim 15, further comprising encrypting the report and transmitting the encrypted report to the manufacturer.

19. The method of claim 15, further comprising transmitting the report to the manufacturer through an encrypting connection.

20. The method of claim 18, further comprising receipt of confirmation that manufacturer has received the encrypted report.

21. The method of claim 18, further comprising receipt of confirmation that manufacturer has received the encrypted report.

22. A system for processing electronic coupons comprising:
a plurality of display devices for displaying coupon information to customers;
a plurality of input devices for customer data entry;
a plurality of data administration devices connected to the plurality of display devices and input devices for processing user selection of coupons and storing coupon information displayed;
a point-of-sale device for redeeming coupons, said point-of-sale device being connected to a point-of-sale administration device; and
a main server for exchanging coupon and customer data with the plurality of data administration devices and with the point-of-sale administration device.

23. The system of claim 22, wherein at least one data administration device includes a radio receiver for identifying a mobile device.

24. The system of claim 22, wherein at least one display device is a touch screen device and the touch screen functions as one of the plurality of input devices.

25. The system of claim 22, wherein at least one of the input devices incorporates an antenna for detection of a mobile device.

26. The system of claim 22, wherein the point-of-sale administration device includes a screen for displaying electronic coupons.

27. The system of claim 22, wherein the point-of-sale device includes a scanner.

28. A method for processing electronic coupons comprising the steps of:
detecting removal of a product from a bin;
displaying promotions of other products in the same bin;
detecting whether one of said other products has been removed from the bin;
detecting a mobile identification number corresponding to a user removing the products from the bin;
creating an electronic coupon and associating said electronic coupon with said removed products; and
transmitting a record with said electronic coupon and customer data to a main server.

29. The method of claim 28, wherein the step of detecting whether one of said products has been removed comprises reading an RFID tag associated with the one of said products.
